(19) United States
(12) Patent Application Publication
(10) Pub. No.: US 2021/0001590 A1
(43) Pub. Date: Jan. 7, 2021

(54) HIGH-TEMPERATURE RESISTANT GLASS DIMMING FILM

(71) Applicant: Wing Tak Lee Silicone Rubber Technology (Shenzhen) Co., Ltd, Shenzhen (CN)

(72) Inventor: Tak Nam LIU, Shenzhen (CN)

(21) Appl. No.: 16/916,218

(22) Filed: Jun. 30, 2020

(30) Foreign Application Priority Data
Jul. 2, 2019 (CN) 2019105915315

(51) Int. Cl. B32B 3/18; B32B 27/08; B32B 27/30; B32B 27/32; B32B 7/12

(52) U.S. Cl. CPC B32B 3/18; B32B 27/08; B32B 27/306; B32B 27/32; B32B 7/12; B32B 2307/584; B32B 2264/1051; B32B 2264/1055; B32B 2264/1056; B32B 2307/306; B32B 2307/304; B32B 2307/412

(57) ABSTRACT

The application provides a high-temperature resistant glass dimming film, which has a multi-layer structure, wherein the multi-layer structure comprises from external to internal: a wear resistant layer, a thermal insulating layer, an ultraviolet-proof layer, an adhesive layer and a transparent base layer; wherein, a hollow layer is arranged between the wear resistant layer and the thermal insulating layer, the hollow layer comprises multiple heat dissipation channels and isolating bars, the multiple heat dissipation channels are arranged horizontally and the width and spacing between the multiple heat dissipation channels are identical.

### CROSS REFERENCE TO RELATED APPLICATION

This patent application claims priority to China Patent Application No. 201910591531.5, filed Jul. 2, 2019, which is hereby incorporated by reference in their entirety.

### TECHNICAL FIELD

The application relates to the field of electronic accessories, and specifically relates to a high-temperature resistant glass dimming film.

### BACKGROUND

Protective film can be classified into protective film for digital products, protective film for automobiles, household protective film, protective film for food preservation and the like, according to its uses. For different scenes of the protective film, the working environment is not the same; and for different working environment, its requirements on temperature are not the same.

The existing protective film cannot meet the requirements of high temperature and low temperature, so the application scenarios of the existing protective film are limited.

### SUMMARY

In embodiments of the application, it provides a high-temperature resistant glass dimming film, which can meet the requirements of high temperature and low temperature, thus improving the application scenarios of the protective film.

In one aspect, an embodiment of the application provides a high-temperature resistant glass dimming film, comprising:

The high-temperature resistant glass dimming film is a high-temperature resistant ultrathin film, which has a multi-layer structure, wherein:

The multi-layer structure comprises from external to internal: a wear resistant layer, a thermal insulating layer, an ultraviolet-proof layer, an adhesive layer and a transparent base layer; wherein, a hollow layer is arranged between the wear resistant layer and the thermal insulating layer, the hollow layer comprises multiple heat dissipation channels and isolating bars, the multiple heat dissipation channels are arranged horizontally and the width and spacing between the multiple heat dissipation channels are identical.

The embodiments of the application have the following beneficial effects:

As can be seen, the schematic diagram of air flow of the high-temperature resistant ultrathin film provided in the application is shown in FIG. 3 (the arrow direction shown in FIG. 3 indicates the direction of air flow). As shown in FIG. 3, at high temperature, the isolating bars of the high-temperature resistant ultrathin film would expand, pushing the wear resistant layer 101 apart from the thermal insulating layer, increasing the thickness of the heat dissipation channels 1061, thus increasing the amount of airflow passing through. The heat dissipation area is thereby increased, dissipating heat from the thermal insulating layer as quickly as possible, thus increasing the temperature of the high-temperature resistant ultrathin film. In the experiments, the above temperature can reach above 120° C. At low temperature, the isolating bars would shrink, decreasing the thickness of the heat dissipation channels 1061, thus reducing the effect of heat dissipation. In the experiments, the above temperature can be as low as −80° C. Therefore, a temperature of −80° C. to 120° C. can be achieved by the high-temperature resistant ultrathin film provided in the application.

### BRIEF DESCRIPTION OF THE DRAWINGS

For illustrating the technical solution in the embodiments of the application more clearly, a brief description of the appended drawings required for describing the embodiments is given below. It is apparent that the appended drawings described below are some embodiments of this application. For persons with ordinary skills in the art, other drawings can also be obtained according to these drawings without creative work.

FIG. 1 is the structure schematic diagram of a high-temperature resistant glass dimming film provided in an embodiment of the application.

FIG. 2 is the schematic diagram showing the heat dissipation channels provided in the application.

FIG. 3 is the schematic diagram showing the heat dissipation circuit provided in the application.

### DESCRIPTION OF THE EMBODIMENTS

The technical solution in the embodiments of the application will be described clearly and thoroughly below accompanying with the appended drawings in the embodiments of the application. It is obvious that the described embodiments are only part of the embodiments of the application, not the entire embodiments. Based on the embodiments in the application, all other embodiments obtained by persons with ordinary skills in the art without creative work are in the protection scope of the application.

The terms “first”, “second”, “third”, and “fourth” and the like used in the description, claims and the appended drawings of the application are used to distinguish between different objects, not describing a particular sequence. In addition, the terms “comprising” and “having” as well as any variations thereof are intended to refer to non-exclusive inclusion. For example, processes, methods, systems or equipment comprising a series of steps or units are not limited to the listed steps or units, but optionally further comprise steps or units not listed, or optionally further comprise other steps or units which are inherent for these processes, methods, products or equipment.

An “embodiment” referred herein means that specific features, structures or properties described in combination with embodiments can be comprised in at least one embodiment of the application. The phrase occurring at various positions in the specification does not necessarily refer to the same embodiment, or an independent or alternative embodiment exclusive with other embodiments. It is understood by the persons skilled in the art explicitly and implicitly that embodiments described herein can combined with other embodiments.

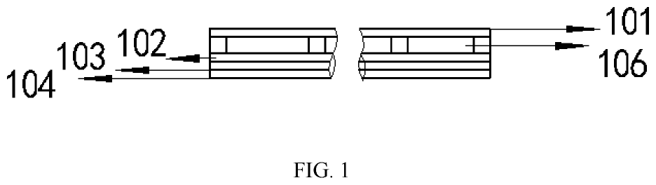

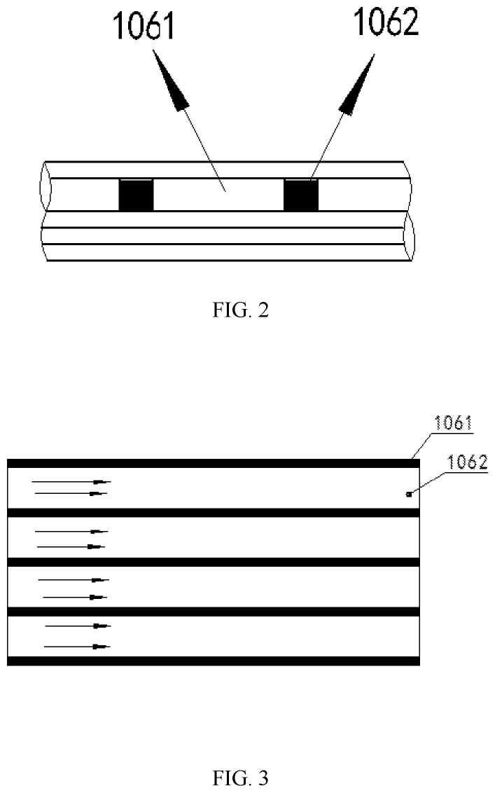

With reference to FIG. 1, it shows a high-temperature resistant ultrathin film. As shown in FIG. 1, the high-temperature resistant ultrathin film has a multi-layer structure. The multi-layer structure comprises from external to internal: a wear resistant layer 101, a thermal insulating layer 102, an ultraviolet-proof layer 103, an adhesive layer 104 and a transparent base layer 105; wherein, a hollow layer 106 is arranged between the wear resistant layer 101 and the thermal insulating layer 102. As shown in FIG. 2, the hollow layer 106 comprises multiple heat dissipation channels 1061 and isolating bars 1062. The multiple heat dissipation channels 1061 are arranged horizontally and the width and spacing between the multiple heat dissipation channels 1061 are identical.

With reference to FIG. 3, it is a schematic diagram of air flow of the high-temperature resistant ultrathin film provided in the application (the arrow direction shown in FIG. 3 indicates the direction of air flow). As shown in FIG. 3, at high temperature, the isolating bars of the high-temperature resistant ultrathin film would expand, pushing the wear resistant layer 101 apart from the thermal insulating layer, increasing the thickness of the heat dissipation channels 1061, thus increasing the amount of airflow passing through. The heat dissipation area is thereby increased, dissipating heat from the thermal insulating layer as quickly as possible, thus increasing the temperature of the high-temperature resistant ultrathin film. In the experiments, the above temperature can reach above 120° C. At low temperature, the isolating bars would shrink, decreasing the thickness of the heat dissipation channels 1061, thus reducing the effect of heat dissipation. In the experiments, the above temperature can be as low as −80° C. Therefore, a temperature of −80° C. to 120° C. can be achieved by the high-temperature resistant ultrathin film provided in the application.

Optionally, the above isolating bars 1062 are made of polyethylene.

Optionally, the above wear resistant layer 101 is a nano ceramic layer.

Optionally, the widths of the above multiple heat dissipation channels 1061 are between 10 mm-20 mm. It is known through many experiments that, if the heat dissipation channels are too wide, the middle parts of the heat dissipation channels will stick together. Due to the thicknesses of the heat dissipation channels are very small, too large width makes the heat dissipation channels fit together partially, while too small width leads to poor heat dissipation effect of the heat dissipation channels in turn. Therefore, the above dimensions are the most suitable. Preferably, the above width (the width is the minimum spacing between the isolating bars) may be 13 mm.

The above transparent base layer 105 can comprise components in the following mass fractions specifically:

| | | |
|---|---|---|
| Polyvinyl alcohol | 10-30 | parts; |
| Ethylene diamine | 8-10 | parts; |
| Isopropanol | 15-20 | parts; |
| Metal powder | 3-5 | parts; |
| Organic toner | 1-2 | parts; |
| Polytetrachloroethylene | 4-6 | parts; |

| | |
|---|---|
| Polyurethane | the remaining. |

The mass fractions of the above components are 100 parts in total.

Optionally, the above metal powder is mixed metal powder of iron powder, copper powder, silver powder and gold powder.

It should be noted that, for the purpose of simple description, all the above method embodiments are expressed as a series of action combinations, but technical personnel in this field should be aware that this application is not limited by the sequence of actions described. That is due to that certain steps may be taken in other order or simultaneously in accordance with the application. Secondly, technical personnel in this field should also be aware that the embodiments described in the specification are optional embodiments and the actions and modules involved are not necessarily necessary for this application.

In the above embodiments, the description of each embodiment stressed on different aspects. For parts not specified in an embodiment, please refer to the relevant descriptions of other embodiments.

In several embodiments provided in this application, it should be understood that the disclosed devices can be realized through other ways. For example, the above described device embodiments are only illustrative. For example, the division of units is only based on logical functions. In actual implementation, the division can be achieved in other ways. For example, multiple units or components can be combined or integrated into another system, or some features can be ignored or not performed. Additionally, the shown or discussed intercoupling or direct coupling or communication connection may be through some interfaces. The indirect coupling or communication connection between devices or units may be electrical or other forms.

The units illustrated as independent components may be or may be not separated physically. The components presented as units may be or may be not physical units, i.e., they may be located at one place, or may be distributed onto multiple network units. Part or all of the units can be chosen to achieve the objectives of the embodiments according to practical requirements.

In addition, various functional units in each embodiment of the application may be integrated in one processing unit, or various units also may exist physically alone, or two or more units may be integrated in one unit. The above integrated units can be realized in forms of hardware or software module.

If realized in a form of software module and sold or used as independent products, the integrated units can be stored in a computer readable memory. Based on such understanding, the technical solution of the application substantially, or part of the technical solution that contributes to the existing technology, or all or part of the technical solution can be embodied in the form of software products. The computer software products are stored in a memory, including several instructions to enable one computer (may be a personal computer, a server or network equipment and the like) to conduct all or part of the steps in the method described in each embodiment of the application. The above memory includes various media for storing program code such as USB flash drive, ROM (Read-Only Memory), RAM (Random Access Memory), mobile HDD (mobile hard disk drive), diskette or compact disc, or the like.

It should be understood by persons with ordinary skills in the art that, all or part of the steps in various methods described in above embodiments can be done by issuing instructions to the relevant hardware through a program. The program can be stored in a computer readable memory. The memory can include flash disk, ROM (Read-Only Memory), RAM (Random Access Memory), diskette or compact disc, or the like.

The foregoing is detailed description of the embodiments of the application. The principle and implementation of the application have been interpreted herein by employing specific embodiments. The description in the above embodiments is only used to facilitate the understanding of the method and core concept of the application. Meanwhile, changes can be made to the specific implementation and application range of the application by persons with ordinary skills in the art following the spirit of the application. In conclusion, the content of specification should not be understood as limitation to the application.

What is claimed is:

1. A high-temperature resistant glass dimming film, wherein the high-temperature resistant glass dimming film has a multi-layer structure, wherein:
the multi-layer structure comprises from external to internal: a wear resistant layer, a thermal insulating layer, an ultraviolet-proof layer, an adhesive layer and a transparent base layer;
wherein a hollow layer is arranged between the wear resistant layer and the thermal insulating layer, the hollow layer comprises a plurality of heat dissipation channels and isolating bars, the plurality of heat dissipation channels are arranged horizontally and the width and spacing among the plurality of heat dissipation channels are identical.

2. The high-temperature resistant glass dimming film of claim 1, wherein the isolating bars are made of polyethylene.

3. The high-temperature resistant glass dimming film of claim 1, wherein the wear resistant layer is a nano ceramic layer.

4. The high-temperature resistant glass dimming film of claim 1, wherein the plurality of heat dissipation channels have widths between 10 mm-20 mm.

5. The high-temperature resistant glass dimming film of claim 1, wherein the transparent base layer comprises components in the following mass fractions:

| | | |
|---|---|---|
| polyvinyl alcohol | 10-30 | parts; |
| ethylene diamine | 8-10 | parts; |
| isopropanol | 15-20 | parts; |
| metal powder | 3-5 | parts; |
| organic toner | 1-2 | parts; |
| polytetrachloroethylene | 4-6 | parts; |
| | |
|---|---|
| polyurethane | the remaining; |

the mass fractions of the above components are 100 parts in total.

6. The high-temperature resistant glass dimming film of claim 5, wherein the metal powder is mixed metal powder of iron powder, copper powder, silver powder and gold powder.
